(19) United States
(12) Patent Application Publication
(10) Pub. No.: US 2005/0084321 A1
(43) Pub. Date: Apr. 21, 2005

(54) Retractable vacuum reservoir applicator and writing tool with self sealing valve

(76) Inventor: Craig David Carroll, Newport Coast, CA (US)

Correspondence Address: Mr. Craig Carroll, 28 Sable Sands, Newport Coast, CA, 92657, US

(21) Appl. No.: 10/967,894

(22) Filed: Oct. 18, 2004

Related U.S. Application Data
(60) Provisional application No. 60/512,961, filed on Oct. 20, 2003.

(51) Int. Cl. B43K 5/16; B43K 5/00

(52) U.S. Cl. 401/108; 401/107

(57) ABSTRACT

This invention provides an inexpensive capless retractable writing tool that utilizes a vacuum controlled reservoir system to store fluid which is conveyed through a feeder to a tip. The invention includes a self sealing valve that seals the tip of the vacuum reservoir from the atmosphere and prevents the release of vapor pressure from within the valve. When the writing tool is in the retracted position, the tip of the vacuum reservoir is between the front and back ends of the valve to substantially seal the tip from outside air and prevent the release of vapor fluid from within the valve. The valve can withstand atmospheric pressure changes without giving rise to leakage of the vacuum reservoir system.

### CROSS REFERENCE TO RELATED APPLICATION

The present invention claims priority to U.S. Provisional Application for Patent Ser. No. 60/512,961 filed Oct. 20, 2003, which application is incorporated herein by reference.

### BACKGROUND OF THE INVENTION

The primary objective of this invention is considered to be that of permitting a manufacturer to provide an array of retractable products that utilize a vacuum reservoir system which holds the fluid by virtue of a slight negative pressure. Vacuum reservoir systems permit more fluid capacity per unit of volume and more fluid flow through the applicator tip. The present invention is in the field of retractable applicators and writing tools, and more particularly, to applicators and writing tools that employ volatile fluids that evaporate when exposed to air. More particularly, the present invention relates to applicators and writing tools having a self sealing valve that seals the applicator or writing tip from the atmosphere and prevents the release of vapor fluid from within the valve. Still more particularly, the self sealing valve protects the vacuum reservoir from changes in atmospheric pressure and allows the applicator or writing tip of the vacuum reservoir to be protracted through the valve, and retracted back into the valve.

Existing applicators and writing tools that use vacuum reservoirs for supplying fluids require tightly sealing caps that protects the fluids from leaking and evaporating. The general principles of such are well known as set forth in, for example, the Wittnebert U.S. Pat. No. 3,951,555. Failure to replace the cap tightly from this type of dispenser causes the fluid to leak and evaporate after a short time.

Many writing tools fall into two categories, retractable and capped type. A ballpoint pen is a good example of a retractable writing tool that includes internal mechanisms to allow the tip to move back and forth inside the front cowling of the pen. Retractable writing tools are convenient to use because with one hand, a user can press and release the plunger back and forth to cause the tip to move back and forth. Once the tip is in the retracted position, the tip is protected from accidentally drop and cannot accidentally write onto a surface.

A roller ball is a good example of a capped writing instrument that needs a cap to seal the tip from the atmosphere. If the cap is left off the roller ball pen, lost or not secured properly, the tip would eventually dry out. In addition, if the cap is left off the roller ball pen or not secured properly the pen will leak if it is exposed to pressure or temperatures changes. This can shorten the life of the roller ball pen. As such, users have to remember to put the cap back on after each use. For users, however, remembering to put the cap back on after each use can be inconvenient.

To eliminate the need for a cap, others have designed a writing tool with a retractable tip that is sealed from the outside air when in the retracted position. The tip is sealed by incorporating some type of a sealing cover around the tip that opens to allow the tip to move in and out of the sealing cover. These sealing covers however, fail to protect the vacuum reservoir from changes in atmospheric pressure.

In addition to the problem with the vacuum reservoir being exposed to atmospheric pressure changes and the tip being exposed to air and vapor fluid escaping through the openings of the sealing cover, current retractable writing tool designs with sealing covers use permeable materials in the fabrication of the sealing covers. Accordingly, there is a need for a retractable writing tool that can protect the vacuum reservoir from atmospheric pressure changes and prevent the loss of vapor fluid that is built up within the sealing cover when the writing tool is in the retracted position.

### BRIEF SUMMARY OF THE INVENTION

The present invention is intended to provide a capless applicator or writing tool applicable to vacuum reservoirs using neutral and volatile fluids and capable of self-sealing, substantially preventing vapor fluid from evaporating through the valve and protecting the vacuum reservoir from changes in atmospheric pressure when the tip is in the retracted position. The present invention includes a front cowling with an opening to allow the tip to move in and out of the opening. Adjacent to the front opening and within the front cowling is a valve that substantially seals the tip from the atmosphere, prevents the release of vapor pressure from within the valve, and protects the vacuum reservoir from changes in atmospheric pressure when the tip is in a retracted position. The writing instrument also includes a back body with a back opening. Disposed within the back opening is a plunger that is adapted to move back and forth axially. When the plunger is forced into the back body cavity, there is provided a mechanism for locking the tip of the vacuum reservoir against the urging force of a compression spring so as to hold the tip in the writing state, the mechanism unlocks the tip of the vacuum reservoir when the plunger is forced further into the back body cavity and the tip of the vacuum reservoir is retracted back into the valve for storage. The valve includes a front end and a back end, where the front end is adapted to open to allow the tip of the vacuum reservoir to extend there through. To open the front end may have a concave configuration or profile with a slit. The slit can be cut or formed into the valve. The front end may have a planner or convex configuration or profile with an elongated axis. To enhance proper closure of the slit and to increase the level of change in vapor and atmospheric pressure the slit can withstand, a tension device may be provided around the front end to substantially seal the slit when the tip of the vacuum reservoir is in the retracted position. The back end of the valve has a hole adapted to substantially seal around the vacuum reservoir that the tip is attached to. To increase the level of change in vapor and atmospheric pressure the back end of the valve can withstand, the interference fit between the hole and vacuum reservoir can be increased. In the retracted position, the tip of the vacuum reservoir is between the front and back ends of the valve to substantially seal the tip from the atmosphere, and to prevent the release of vapor pressure from within the valve, thereby eliminating the need for a cap.

With vacuum reservoir capped writing tools the cap must withstand increases in ambient temperature and decreases at atmospheric pressure. If the vacuum reservoir capped writing tool is not sealed to withstand an atmospheric pressure of 9 pounds per square inch, the vacuum reservoir will leak fluid into the cap.

To solve the above mentioned problem, a capless writing tool is provided comprising a valve having a front end and a back end that substantially seals the tip of the vacuum reservoir from atmospheric pressure changes. The valve for the present invention may be made from a material that is impermeable to outside air and vapor fluid. The valve may be made of a material that is durable so that the slit will not wear out after the tip is moved in and out many times.

Other systems, methods, features, and advantages of the invention will be or will become apparent to one with skill in the art upon examination of the following figures and detailed description. It is intended that all such additional systems, methods, features, and advantages be included within this description, be within the scope of the invention, and be protected by the accompanying claims.

The present invention disclosed herein provides a retractable applicator or writing tool and self-sealing valve capable of protecting a vacuum reservoir from atmospheric pressure changes and allowing for one hand operation, by push button, to retract and protract a tip of the vacuum reservoir stored within the valve.

This design is simple to manufacture and assemble enabling high volume low-cost manufacturing. These are requirements to be a competitive and saleable product in the market. In addition, the design has the enhanced feature and added value, to the end consumer, of being capless, child safe, self-sealing and relatively inexpensive to manufacture, and thus purchase.

### BRIEF DESCRIPTION OF THE DRAWINGS

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a cross-sectional view of a retractable writing tool in the retracted state constructed in accordance with one embodiment of the present invention showing its component parts in operative assembled relationship.

FIG. 2 is a cross-sectional view of a retractable writing tool in the protracted state constructed in accordance with one embodiment of the present invention showing its component parts in operative assembled relationship.

FIG. 3 illustrates a writing tool that is disassembled.

FIG. 4 illustrates cross-sectional view of a vacuum reservoir with one embodiment of the present invention showing its component parts in operative assembled relationship.

### DETAILED DESCRIPTION OF THE INVENTION

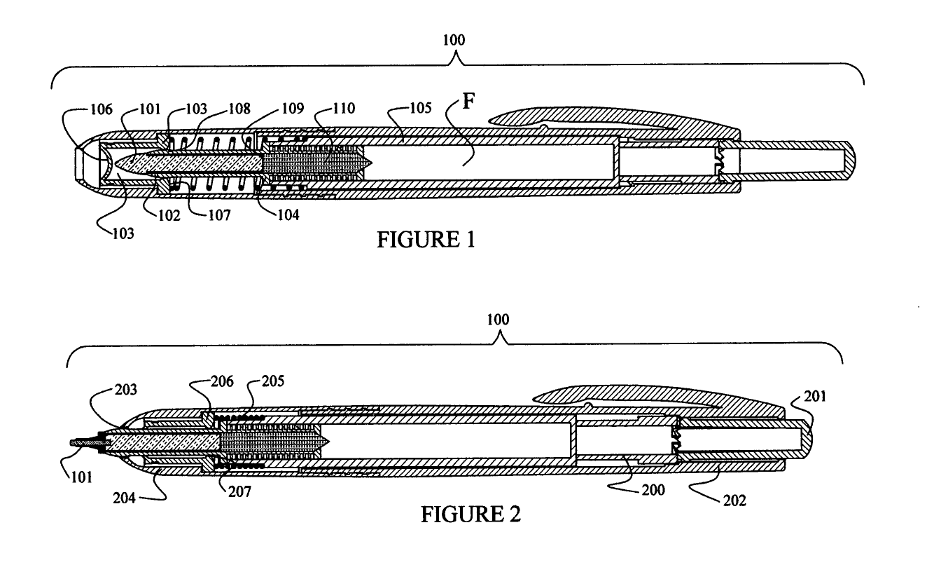

FIG. 1 illustrates the cross-sectional view of the applicator or writing tool 100 in a retracted position. In the retracted position, the tip 101 and vent 102 are within the enclosure 103 with the front end 106 substantially forming a seal, and the back end 107 substantially forming a seal around the elongated portion 108 of the finned collector 104. The back tip 109 makes contact with the feeder 110 so that the fluid F stored in the reservoir 105 conveys through the feeder 110 and through the tip 101. In the retracted position the tip 101 and vent 102, are substantially sealed within the enclosure 103.

FIG. 2 illustrates the cross sectional view of the writing tool 100 in the protracted position. The writing tool 100 includes a gear 200 that works with the plunger 201 and the rear barrel 202 to lock the plunger 201 in the retracted position or the protracted position. To extend the tip 101 outside the opening 203, the plunger 201 is activated or pushed towards the rear barrel 202. This causes the reservoir 105, finned collector 104, feeder 110, and the tip 101 to move forward towards the opening 203. As the tip 101 is pushes against the front end 106 of valve 206, the front end 106 opens to allow the tip 101 to pass through the opening 203 of the front barrel 204. The compression spring 205 resist against the pushing force until the gear 200 engages and locks in the protracted position. The tip 101 is now ready for the user to apply the fluid to a surface.

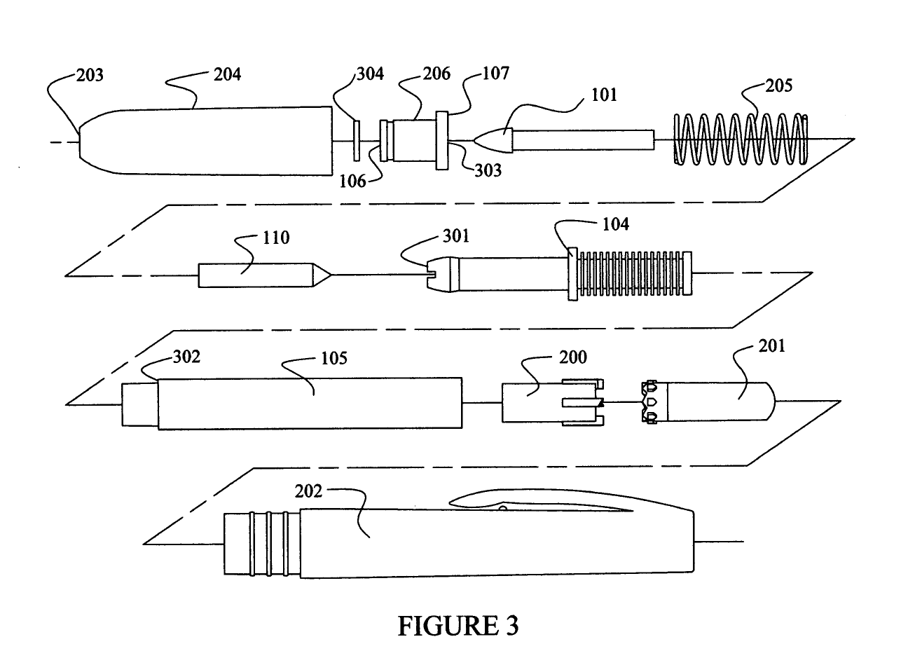

FIG. 3 illustrates the interior components of the writing tool 100. The writing tool 100 includes a valve 206 adapted to fit within the front barrel 204 adjacent to the opening 203. The valve 206 has a front end 106 and a back end 107 forming an enclosure 103 within the valve 206. The enclosure 103 is adapted to receive the tip 101 and vent 102 of finned collector 104 to substantially seal the tip 101 and vent 102 from the outside air and protect the vacuum reservoir from changes in atmospheric pressure.

The writing instrument 100 also includes a reservoir 105 adapted to a finned collector 104. The reservoir 105 and finned collector 104 are adapted to store fluid that conveys through the feeder 110 and through the tip 101. The capillary relationship among the feeder 110 and tip 101 causes the writing fluid to convey from the feeder 110 to the tip 101. The finned collector 104 has an elongated portion 108 with a first opening 301 adapted to receive the feeder 110 and tip 101. This allows the tip 101 to make contact with the feeder 110 to convey the fluid F from the reservoir 105 to the feeder 110 to the tip 101. The reservoir 105 has a back flange 302 adapted to associate with a compression spring 205. The elongated portion 108 of the finned collector 104 may be inserted through the compression spring 205 such that the compression spring 205 is positioned between the first opening 301 and the back flange 302 of reservoir 105.

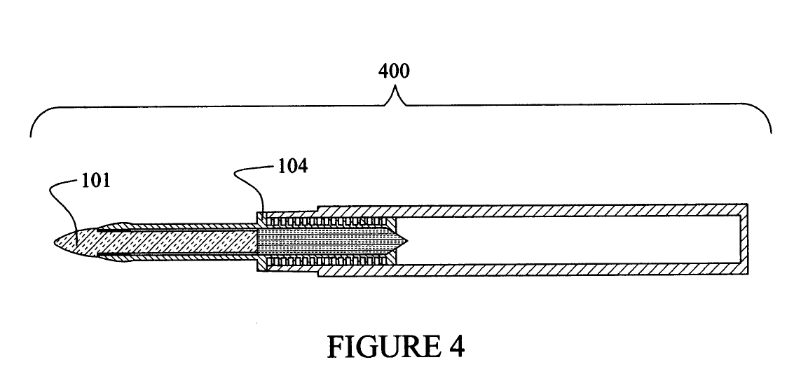

FIG. 4 illustrates a cross sectional view of the vacuum reservoir 400 with another embodiment of the tip 101 that is adapted to engage within the first opening 301 of finned collector 104. A variety of different types of tips known to one skilled in the art can be adapted to the first opening 301 of finned collector 104.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

1. A retractable writing tool comprising:
A rear barrel (202) and a front barrel (204) having an opening (203) and a tip (101) capable of moving between a retracted position and a protracted position;
a vacuum reservoir (400) for storing a supply of fluid comprising a reservoir (105) a finned collector (104) and a feeder (110) capable of conveying fluid to a tip (101), and a valve (206) having a front end (106) and a back end (107), where the front end (106) and back end (107) substantially seal the tip (101) from atmospheric pressure changes to substantially prevent the fluid from leakage into the enclosure (103) when the tip (101) is in a retracted position, where in the protracted position, the tip (101) extends through the front end (106) of the valve (206) and opening (203) of the front barrel (204), where the valve (206) is made of fluorocarbon.

2. The valve (206) of claim 1, where the back end (107) has a hole (207) that is adapted to seal around the elongated portion (108) of the finned collector (104) of vacuum reservoir (400).

3. The valve (206) of claim 1, where the valve is adapted to seal the tip (101) from the atmosphere when the tip (101) is in the retracted position.

4. The valve (206) of claim 1, where the valve is adapted to seal the vent (102) from the atmosphere when the tip (101) is in the retracted position.

5. The valve (206) of claim 1, where the diameter of the hole (207) is less than the diameter of the elongated portion (108) of the finned collector (104) to substantially seal the hole (303) to withstand a reduction in atmospheric pressure.

6. The valve (206) of claim 1, where the front end (106) substantially seals to withstand a reduction in atmospheric pressure when the tip (101) is in the retracted position.

7. The valve (206) of claim 1, where the valve can withstand 9 pounds per square inch of atmospheric pressure without giving rise to leakage of the vacuum reservoir (400) when the tip (101) is in the retracted position.

8. The valve (206) of claim 1, where the diameter of the hole (303) is less than the diameter of the elongated portion (108) of the finned collector (104) to substantially seal the hole (303) to withstand between 0 and 9 pounds of pressure from within the enclosure (103).

9. The valve (206) of claim 1, where the front end (106) substantially seals to withstand between 0 and 9 pounds of pressure from within the enclosure (103) when the tip (101) is in the retracted position.

10. The valve (206) of claim 1, further including a tension device (304) around the front end (106) to substantially seal the front end (106) to withstand 0 to 9 pounds of pressure from within the enclosure (103) when the tip (101) is in the retracted position.
